(19) United States
(12) Patent Application Publication
(10) Pub. No.: US 2003/0050029 A1
(43) Pub. Date: Mar. 13, 2003

(54) Fast locking wide band frequency synthesizer

(76) Inventors: Yaron Kaufmann, Tel Aviv (IL); Alexander Mostov, Rishon Letzion (IL); Oren Eliezer, Kfar Saba (IL)

Correspondence Address: TEXAS INSTRUMENTS INCORPORATED, P O BOX 655474, M/S 3999, DALLAS, TX, 75265

(21) Appl. No.: 09/947,965

(22) Filed: Sep. 6, 2001

(51) Int. Cl. H04B 1/06

(52) U.S. Cl. 455/260; 455/186.1; 455/190.1; 455/266

(57) ABSTRACT

A novel frequency synthesizer incorporating a band switching VCO having a low K_{VCO} tuning factor enabling operation with low supply voltage and low susceptibility to noise and frequency pulling. The VCO has a low tuning factor that covers only a small portion of the operating frequency range, depending on the number of bands into which the frequency range is divided. The normal phase locked loop operation of the synthesizer is preceded by an open loop band selection procedure which results in faster lock time and a lower required tuning voltage range for the VCO. The frequency band selection is made using frequency measurements. Alternatively, a band select LUT and channel LUT are generated a priori during a calibration stage in order to speed frequency acquisition and band selection.

### FIELD OF THE INVENTION

The present invention relates generally to radio frequency (RF) frequency synthesizers and more particularly relates to a low voltage, fast locking frequency synthesizer that permits use of a band switching VCO having a low K_{VCO} factor for its frequency control input.

### BACKGROUND OF THE INVENTION

Achieving wide band frequency coverage in conventional voltage controlled oscillators (VCOs) requires that the VCO have a wide tuning voltage range. This is often difficult to implement and creates modulation-related problems particularly in VCOs that are intended to be used for frequency modulation (either digital or analog). The implementation difficulties arise from voltage supply limitations and the modulation related problems arise due to the fact that typically a single tank circuit is used to determine the center frequency of the oscillator. In order to achieve a wide frequency range while maintaining a reasonable level of sensitivity tuning factor, a consequently wide tuning voltage range is required. VCOs having very wide tuning ranges are not generally available since they are difficult to construct. In addition, wide tuning voltage ranges cannot be used if the VCO is intended to operate in low voltage environments.

Traditional frequency synthesizer design becomes problematic when the supply voltage is low and the frequency range is required to be relatively wide. In order to achieve a wide frequency tuning range with a reasonable control voltage range, a VCO having a high tuning/modulation factor known as K_{VCO} (in units of MHz/V) must be used. A very high K_{VCO} factor for the frequency control input of the VCO is required in order to cover the wide frequency range over a small input voltage range while also taking into account IC fabrication process and component tolerances.

A consequence of using a high K_{VCO} tuning factor, however, is that the tuning input of the VCO becomes highly sensitive to additive noise and more prone to extraneous signal pick up. This causes the phase noise level of the oscillator to increase resulting in the degradation of the performance of the system that incorporates the VCO. Another common problem found in such circuits is frequency pulling caused by the pick up of RF signals within the tuning tank. In addition, costly shielding may be required to prevent pick up of noise and RF signals.

In cases where the VCO is used to directly generate the output carrier frequency, as is the case in direct conversion receivers, the large tuning factor results in FM parasitic frequency modulation caused by even a few microvolts of noise. Demodulating a signal with a varying LO results in a modulation output having frequency deviations at a certain rate. The degree of vulnerability is proportional to the tuning factor and the particular frequencies used.

Other consequences of using a VCO with a large tuning factor include increased susceptibility to noise due to spikes generated in digital logic and from baseband or RF signals that leak into the VCO control voltage input or that are in the frequency range of the tank circuit in the VCO.

One approach to overcoming the problem of manufacturing and using a VCO having a large tuning factor is to employ a tuning procedure at the time of manufacture and generating and storing compensation data in a non-volatile memory for use during operation of the VCO. This, however, adds to the complexity and cost of the circuitry.

Therefore, it is desirable to have a frequency synthesizer that is capable of generating a wide range of frequencies with a reduced lock time, exhibits a low tuning factor to enable operation in low voltage circuits and has low susceptibility to noise and RF pickup commonly encountered in RFICs.

### SUMMARY OF THE INVENTION

The present invention is a novel frequency synthesizer incorporating a band switching VCO having a low K_{VCO} tuning factor thus enabling operation using a low voltage supply, while offering immunity to parasitic FM caused by noise pickup and RF leakages. The VCO has a low tuning factor that covers only a small portion of the operating frequency range, depending on the number of bands into which the frequency range is divided. The band switching characteristic of the synthesizer enables fast lock times.

The frequency synthesizer of the present invention incorporates a VCO having the ability to switch frequency bands among a plurality of bands. The frequency synthesizer has applications in any circuit that requires a VCO having fast lock times, low voltage operation and that is tunable over a wide frequency range. Such applications include, but are not limited to, phase lock loop circuits and time-division-duplex (TDD) wireless transceivers for two-way communications.

The invention also has applications in frequency hopping transceiver applications as well, such as transceivers designed in accordance with the well-known Bluetooth wireless communications protocol. The receiver local oscillator frequencies in these transceivers may be higher or lower than the transmission frequencies by an amount equal to the system's first IF (intermediate frequency), and are typically generated by the same VCO used as the carrier frequency used for transmission.

Another application in which the invention may be implemented is in a transmitter, receiver or transceiver wherein the synthesizer is to have a wide frequency range of coverage while exhibiting as low a K_{VCO} tuning factor as possible.

A typical application in which the implementation of the present invention is advantageous is in an integral radio transmitter/receiver where the same oscillator that is used for modulating the transmitted signal is also used to generate the local oscillator signal required for frequency conversion in the receiver. In such a transceiver, where transmission and reception are not simultaneous, i.e., TDD, the oscillator is required to provide a subset of frequencies during transmission and a different subset of frequencies during reception in accordance with the frequency conversion scheme of the receiver.

The synthesizer of the present invention utilizes a VCO having a plurality of bands whereby each band comprises a narrow range of frequency with a limited tuning voltage range. The ability to switch between frequency bands permits the VCO to maintain a relatively low tuning factor within each of the frequency bands thus enabling low K_{VCO}. Each band covers only a small portion of the operating frequency range depending on the number of bands the entire range is divided into. The band switching is typically realized by switching various components such as capacitors, inductors or variable-capacitors that are used in the tank circuit of the oscillator in and out of the circuit. The switching of the components causes the VCO to shift from one band to another. Thus, the frequency tuning range of the VCO is extended without extending the actual tuning voltage range (on a single variable capacitance diode, for example) and without imposing a high tuning factor.

The synthesizer is constructed from a phase locked loop comprising a frequency source, phase detector, loop filter, band switching VCO and a programmable divider/counter to close the loop. The VCO comprises a tank circuit coupled to an oscillator circuit. The tank circuit comprises a frequency range switching ability capability. Any type of component, e.g., capacitor, inductor, etc. may be used as the switched element. A band select control signal is input to the tank circuit to select one of a plurality of bands.

In one embodiment, the normal phase locked loop operation of the synthesizer is preceded by an open loop band selection procedure which results in faster lock time and a lower required tuning voltage range for the VCO. The frequency band selection is made using frequency measurements performed with the programmable divider/counter used in the counter mode of operation and with the band switching mechanism.

A reference voltage is used to generate a VCO output having a frequency in the center of the band. The frequency is measured using the programmable divider/counter in counter mode and the frequency band selection is based on the measured frequency. Once the band is selected, the loop is closed to permit normal phase locked loop operation.

In a second embodiment, a band select and channel LUT are generated a priori during a calibration stage. Once generated, the channel LUT is used to rapidly look up the band corresponding to a desired channel or frequency resulting in faster frequency acquisition which is advantageous in frequency hopping spread spectrum wireless communications systems. In addition, for the case of a ¼ band overlapping scheme, faster acquisition is achieved by sensing the position of the current tuning voltage and comparing it to the desired channel. The band selection method attempts to minimize the distance the VCO tuning voltage must move from one channel to the next. Thus, the invention attempts to realize most the bulk of the frequency movement required using band switching thus minimizing the amount of frequency change required using the tuning voltage.

There is provided in accordance with the present invention a frequency synthesizer loop comprising a band switching voltage controlled oscillator (VCO) adapted to operate in any of a plurality of bands in response to a band select signal and adapted to generate a VCO output having a frequency proportional to a VCO tuning input signal, a programmable divider/counter adapted to provide both frequency dividing and frequency counting functions, a phase comparator adapted to generate signals proportional to the phase differences between a frequency reference signal and a divider output signal so as to generate a phase error signal therefrom, a loop filter adapted to filter the phase error signal so as to generate the VCO input tuning signal therefrom, band select means adapted to place the frequency synthesizer loop in open loop operation, measure the frequency of the VCO output utilizing the counter function, select one of the plurality of bands in response to the frequency measurement and place the frequency synthesizer loop in closed loop operation.

There is also provided in accordance with the present invention a frequency synthesizer loop for generating a plurality of channel frequencies comprising a band switching voltage controlled oscillator (VCO) adapted to operate in any of a plurality of bands in response to a band select signal and adapted to generate a VCO output having a frequency proportional to a VCO tuning input signal, a programmable divider/counter adapted to provide both frequency dividing and frequency counting functions, a phase comparator adapted to generate signals proportional to the phase differences between a frequency reference signal and a divider output signal so as to generate a phase error signal therefrom, a loop filter adapted to filter the phase error signal so as to generate the VCO tuning input signal therefrom, a channel look up table (LUT) adapted to store band information corresponding to a plurality of channels and band select means adapted to select one of the plurality of bands in accordance with band information read from the channel LUT corresponding to a desired channel.

### BRIEF DESCRIPTION OF THE DRAWINGS

The invention is herein described, by way of example only, with reference to the accompanying drawings, wherein:

FIG. 1 is a block diagram illustrating the frequency synthesizer using a band switching VCO constructed in accordance with the present invention;

FIG. 2 is a schematic diagram illustrating the band switching VCO of FIG. 1 in more detail;

FIG. 3 is a flow diagram illustrating the frequency measurement method of the present invention;

FIG. 4 is a timing diagram illustrating frequency measurement and band selection timing;

FIG. 5 is a diagram illustrating a non-overlapping frequency band assignment scheme;

FIG. 6 is a diagram illustrating a ¼ overlapping frequency band assignment scheme;

FIG. 7 is a diagram illustrating a ½ overlapping frequency band assignment scheme;

FIG. 8 is a flow diagram illustrating a second frequency synthesis method of the present invention;

FIG. 9 is a flow diagram illustrating a first frequency synthesis method of the present invention;

FIGS. 10A and 10B are a flow diagram illustrating the calibration and channel LUT generation method of the second embodiment in more detail; and

FIG. 11 is a flow diagram illustrating the band selection method of the second embodiment in more detail.

DETAILED DESCRIPTION OF THE INVENTION
Notation Used Throughout
The following notation is used throughout this document.

| Term | Definition |
|---|---|
| CPU | Central Processing Unit |
| DC | Direct Current |
| FM | Frequency Modulation |
| IC | Integrated Circuit |
| IF | Intermediate Frequency |
| ISM | Industrial Scientific Medical |
| LO | Local Oscillator |
| LUT | Look Up Table |
| PLL | Phase Locked Loop |
| RF | Radio Frequency |
| RFIC | Radio Frequency Integrated Circuit |
| TDD | Time Division Duplex |
| U/L | Upper/Lower |
| VCO | Voltage Controlled Oscillator |

### Detailed Description of the Invention

The present invention is a frequency synthesizer incorporating a band switching VCO having a low K_{VCO} tuning factor thus enabling operation using low supply voltage. The VCO has a low tuning factor covering only a small portion of the operating frequency range, depending on the number of bands the frequency range is divided into.

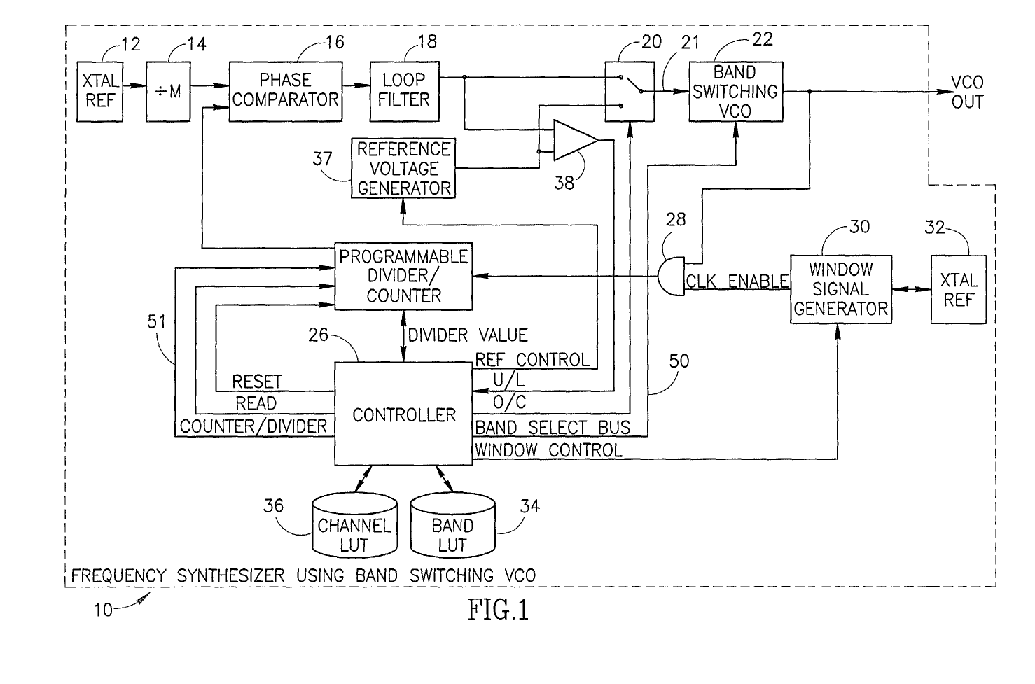

A block diagram illustrating the frequency synthesizer using a band switching VCO constructed in accordance with the present invention is shown in FIG. 1. The frequency synthesizer, generally referenced 10, comprises a phase locked loop (PLL) including a phase comparator 16, loop filter 18 and band switching VCO 22. One input to the phase comparator comprises a frequency reference signal generated from a frequency reference source 12 and subsequently divided down using a divide by M frequency divider 14. The frequency reference source may comprise any frequency source, e.g., temperature compensated crystal oscillator, etc., having the accuracy required for the particular implementation.

The second input to the phase comparator comprises the output of a dual function programmable divider/frequency counter 24. The output of the phase comparator is input to the band switching VCO. The VCO is operative to generate an output signal whose frequency is proportional to the VCO input voltage 21 input thereto. The VCO output is fed back to the input of the programmable divider/counter.

In accordance with the invention, the frequency synthesizer loop employs a band switching VCO whereby the desired frequency range is divided into a plurality of bands. The frequency range of each band is much smaller than the entire range, thus permitting a much lower tuning factor. The synthesizer 10 is adapted to operate in either open or closed loop mode. The open loop mode is typically used to calibrate the frequency bands of the VCO and/or to rapidly select a band by letting the VCO free run. Once the band is selected, the loop is closed. This results in reduced lock time and tuning voltage range requirements for the VCO, resulting in reduced susceptibility to noise and frequency pulling effects.

A switching device 20, e.g., analog multiplexer, double pole, single throw switch, etc. is used to switch between open and closed loop operation. In open loop, the output of the loop filter is disconnected from the input of the VCO. Instead, the output of a reference voltage generator 37 is electrically connected to the input of the VCO. During closed loop operation, the switch is configured to electrically couple the output of the loop filter to the VCO input.

In operation, to set a particular frequency, one of the available VCO bands is selected and the programmable divider is configured with an appropriate value. For example, consider a 2456 MHz signal in the 2.4 GHz ISM band and a 1 MHz frequency reference signal input to the phase comparator. The band switching VCO is configured to the band whose center frequency is closest to the desired frequency and the programmable divider is configured with the value 2456 so as to configure the divider as a divide by 2456 since the output will be compared to a 1 MHz frequency reference signal.

The synthesizer 10 comprises a controller 26 which functions to control the operation of the synthesizer including generating a band select signal input to the VCO, an open/closed loop command signal input to the switching device and a counter/divider control signal 51 and divider value input to the programmable divider/counter.

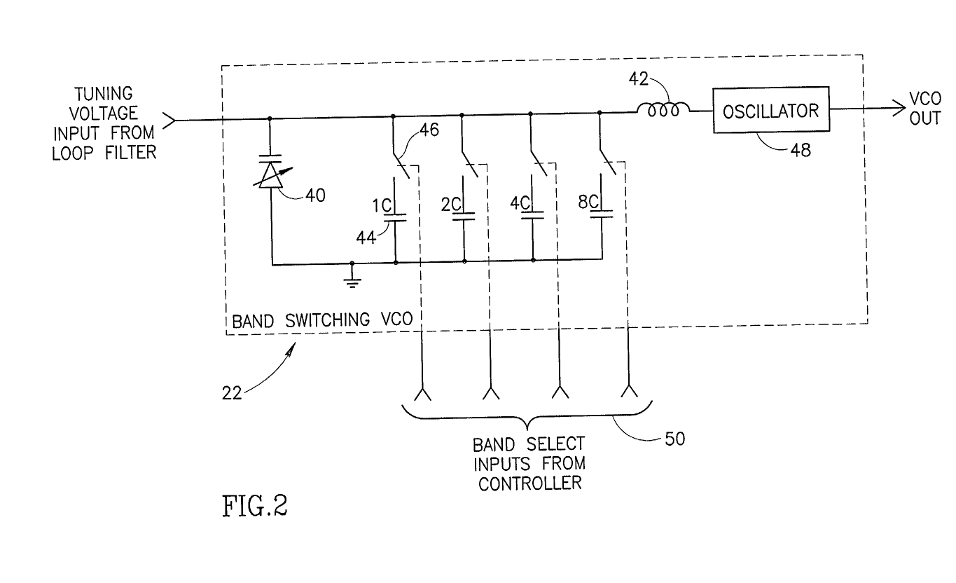

The band switching VCO will now be described in more detail. A schematic diagram illustrating the band switching VCO of FIG. 1 in more detail is shown in FIG. 2. The band switching VCO 22 comprises a tank circuit coupled to an oscillator circuit 48. The tank circuit comprises a varactor 40, inductor 42 and a plurality of switched capacitors constructed from switches 46 and capacitors 44.

Different frequency bands are selected by switching one or more capacitors in and out of the circuit. The switches couple their corresponding capacitors into and out of the tank circuit in accordance with input control signals 50 from the controller. The switching action may be performed using any suitable means, e.g., signal diode, PIN diode, etc. The switched capacitors may have any value but preferably the value of each adjacent capacitor doubles in value from the preceding capacitor in order to simplify selection via binary control. In the example shown herein, four capacitors are included, having the values 1C, 2C, 4C and 8C, thus providing for 16 different unique capacitor combinations corresponding to 16 different frequency bands. In this example, the desired band can be configured using a 4-bit bus. Note that C can be set to any value depending on the desired frequency and particular implementation.

Tuning of the frequency of oscillation within a selected frequency band is achieved by applying a positive tuning voltage to the cathode of the varactor (i.e. reverse bias). It is important to note that the value of the capacitors is critical to the oscillation frequency. Capacitors 44, together with the other resonant components, determine the frequency of oscillation.

Any suitable oscillator circuit 48 may be used in the band switching VCO, such as a grounded base Colpitts oscillator or grounded base Clapp oscillator. VCO circuits with the capability of switching resonant frequencies are known in the art. Circuits suitable for use with the present invention include U.S. Pat. No. 4,694,262, issued to Inoue et al. and U.S. Pat. No. 4,536,724, issued to Hasegawa et al. which discloses a VCO having an LC resonant circuit which includes a varactor circuit configured so as to control the resonant frequency by means of a DC bias control voltage applied to the varactor circuit. Note that the invention is not limited to a particular type or implementation of VCO or oscillator as other well known band switching VCO and oscillator circuit structures are also contemplated to be within the scope of the invention.

In accordance with the present invention, fast locking of the VCO is achieved by first selecting one of a plurality of frequency bands followed by conventional phase lock loop operation to generate the desired output frequency. Band selection may be performed using several possible schemes described in more detail hereinbelow. One technique employs an open loop band selection procedure followed by regular phase lock loop operation. As part of the open loop band selection procedure, the frequency of the VCO output is measured.

Frequency measurements are performed by configuring the programmable divider/counter for frequency counter operation via the counter/divider control signal 51 generated by the controller. A clock enable signal, representing a count window and having a known time period, is generated and input to gate 28 which functions to gate the VCO output. The counter functions to count the number of pulses received during the window period. At the end of the count window, the counter value is used to determine the frequency of the VCO output. For example, if the count window period is one microsecond long, the number of resultant count indicates the frequency of the VCO output in MHz.

The clock enable signal is generated by window signal generator circuit 30 which may comprise a one shot or equivalent circuit. The generation of the clock enable signal is triggered via the window control signal output from the controller. An accurate frequency reference 32 used as the reference frequency source by the window signal generator. The frequency reference may comprise a crystal oscillator, etc. Note that the frequency reference 12 used for the phase comparator may be the same as that used for the window signal generator.

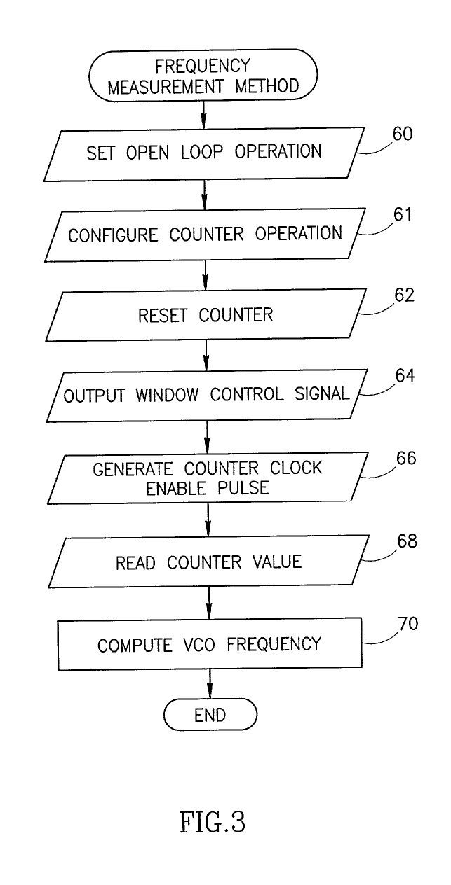

A flow diagram illustrating the frequency measurement method of the present invention is shown in FIG. 3. First, the controller is operative to set open loop operation (step 60) and output the count/divide signal to configure frequency counter operation (step 61). The counter is then reset (step 62) and the window control signal is then generated (step 64) which triggers the generation of the counter clock enable window pulse (step 66). Depending on the implementation, step 64 may not be a separate controller initiated step. After the clock enable pulse (the window interval), the count value is read (step 68) and the frequency of the VCO output computed, such as via internal CPU computations or using other suitable computing means depending on the implementation (step 70).

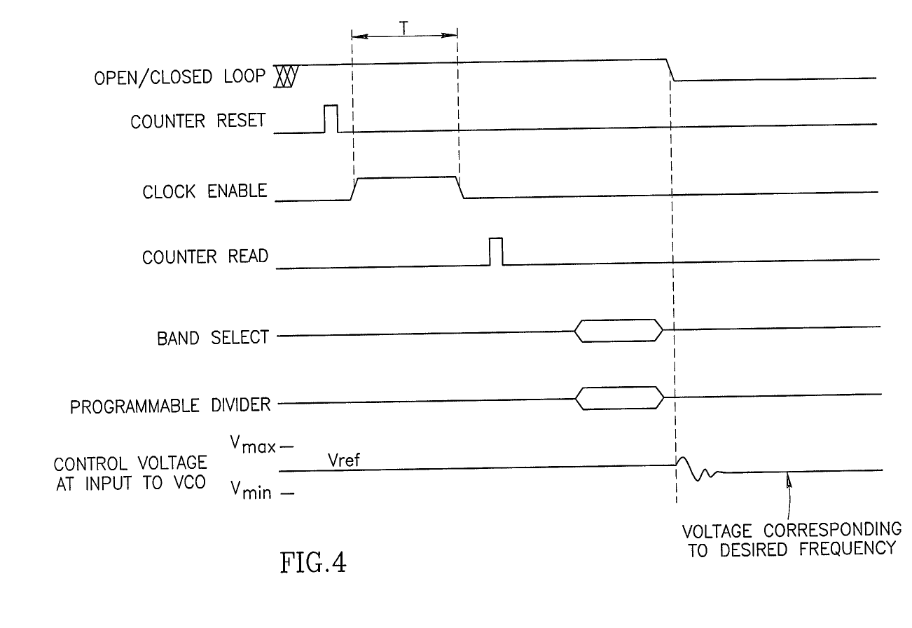

A timing diagram illustrating frequency measurement, band selection timing and signal at the VCO analog control input is shown in FIG. 4. The open/closed loop signal is set to open (i.e. high) followed by the counter reset signal. The clock enable signal is generated for a known time period T. The counter is then read and a frequency determined. In one embodiment, the frequency measured is used by the controller in selecting a band. Once selected, the controller outputs the band select signal to the VCO. The programmable divider is then configured for operation with a value corresponding to the desired output frequency.

The analog control voltage 21 at the input to the VCO is shown while the loop is open and after it closes. The loop is closed when the programmable divider is configured with a value corresponding to the desired output frequency and the output frequency of the VCO eventually stabilizes on the desired frequency.

In another embodiment, the bands for a plurality of channels are predetermined and stored in a channel LUT 36 accessible by the controller. The frequencies of each of the possible bands are also stored in a band LUT 34 also accessible by the controller. Note that the band and channel LUTs can optionally be accessible alone or in combination by an external host computing device, depending on the implementation.

Note that the band switching VCO may be constructed such that individual bands have any frequency range. The bands may be designed to be either overlapping or non-overlapping. An example of non-overlapping frequency bands is shown in FIG. 5. In this example, five bands, band 1 through band 5, are shown wherein each has a center frequency, i.e. f_{c1} through f_{c5}. This scheme covers the maximum frequency range for a given number of bands assuming a fixed width for each band. Any assignment of frequency bands, however, preferably takes into account the difficulty of achieving accurate widths and edges of the bands due to component inaccuracies, temperature drift, etc.

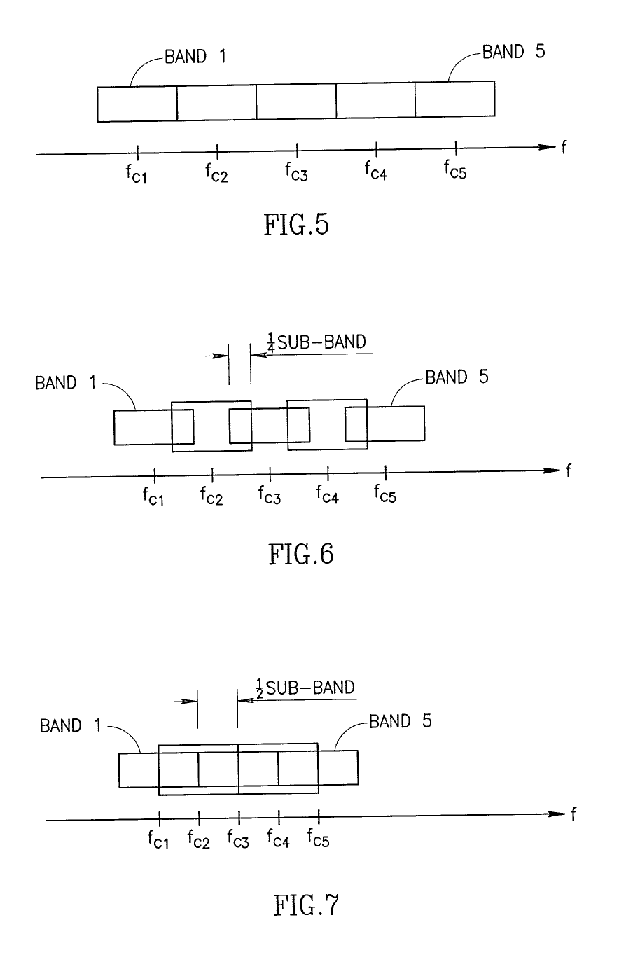

A second band assignment scheme is shown in FIG. 6 which implements ¼ band overlapping. In this scheme, each band overlaps the adjacent band by 25%. The center frequencies of each band are closer together and cover a frequency range 25% less than the non-overlapping case shown in FIG. 5. Assigning frequency bands using this approach provides a higher probability that all frequencies within the full range of the synthesizer can be generated.

A third band assignment scheme is shown in FIG. 7 which implements ½ band overlapping. In this scheme, each band overlaps the adjacent band by 50%. The center frequencies of each band are closer together and therefore the same number of bands of the same width together cover a frequency range 50% less than the non-overlapping case shown in FIG. 5. This scheme limits the maximum frequency swing achieved through the VCO tuning input to ½ band thus achieving faster lock times than the other two schemes.

Note that the frequency assignment schemes are presented herein as examples only. Other frequency assignment schemes having any degree of overlap or non-overlap are also intended to fall within the scope of the present invention.

The frequency synthesizer of the present invention can be adapted to operate in several modes, each using any desired frequency assignment scheme. Two representative embodiments are presented as illustrative examples. The first embodiment achieves a fast lock time utilizing the frequency measurement and band switching capabilities of the frequency synthesizer 10. The second embodiment makes band assignments a priori for a plurality of channels. The related band information is stored in the channel LUT 36 (FIG. 1).

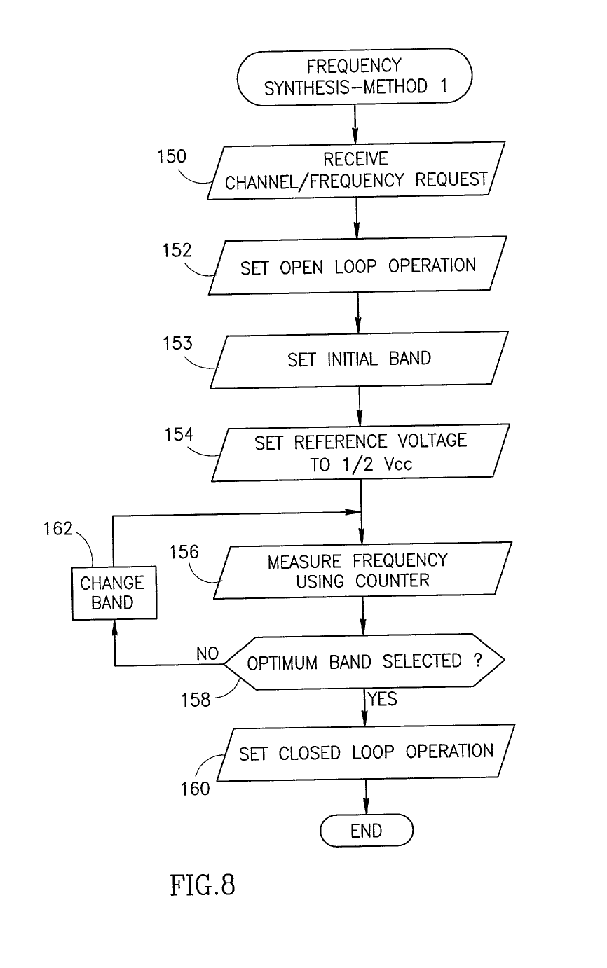

The first embodiment will now be described in more detail. A flow diagram illustrating a second frequency synthesis method of the present invention is shown in FIG. 8. In this embodiment, the normal phase locked loop operation is preceded by an open loop band selection procedure which results in faster lock time and a lower required tuning voltage range for the VCO. The frequency band selection is made using frequency measurements performed with the programmable divider/counter used in the counter mode of operation and the band switching mechanism.

It is assumed that initially, the controller receives a channel or frequency request from an external source, i.e. host controller, etc. (step 150). For example, the synthesizer may be used to generate the carrier of the local oscillator in a frequency hopping transmitter, receiver or transceiver. The controller then configures the loop for open loop operation (step 152). This is achieved by configuring the switching device 20 to input the reference voltage rather than the loop filter output to the VCO. The controller then selects an initial band and configures the VCO therewith (step 153). Note that the initial band may be determined using any suitable technique including, for example, (1) random guess, (2) band select LUT generated during a calibration phase wherein the center frequencies of each band are stored, (3) calculation, and (4) channel LUT generated during a calibration phase wherein the band whose center frequency corresponds closest to the particular channel is stored.

The controller then configures the reference voltage generator to output a reference voltage at the center of the input voltage range of the VCO, e.g., ½ V_{CC} (step 154). This adjusts the VCO output frequency to the center of the selected band. Other ways of achieving this include modifying the phase comparator/detector 16 to output a high rate 50% duty cycle signal that produces a ½ VCC voltage level at the output of the loop filter. In this case, the reference voltage generator may be replaced with suitable means for generating the 50% duty cycle signal either internal with or external to the phase comparator.

The VCO at this point is free running open loop and generating an output signal having a frequency at the center of the selected band. This frequency is then measured using the frequency counter function of the programmable divider/counter 24 in accordance with the frequency measurement method of FIG. 3 described supra (step 156). In this method, the number of cycles of the output signal within a predetermined reference time window is counted.

The controller then determines whether band selection is complete using the frequency measured (step 158). Any criterion may be used including, for example, whether the selected frequency is as close as possible to the desired frequency within some tolerance, or whether a predefined criterion is met such as the number of approximation steps or the difference between the measured frequency and the desired value. If the optimum band is not currently selected, the controller chooses another band using any suitable algorithm, e.g., binary search, successive approximation, etc. and the VCO is configured according with the new band selection (step 162). The frequency of the VCO output is measured again and the cycle repeats until band selection is complete, e.g., the output frequency is within a predetermined tolerance or the difference between the measured frequency and the desired value is within a predefined tolerance.

The frequency synthesizer is then set to operate in closed loop configuration (step 160). The time to achieve lock at this point (i.e. arrive at the correct tuning voltage) depends on the band selection quantization error, the distance from the initial value of the tuning voltage, which the closed loop will compensate for, and the closed loop dynamics.

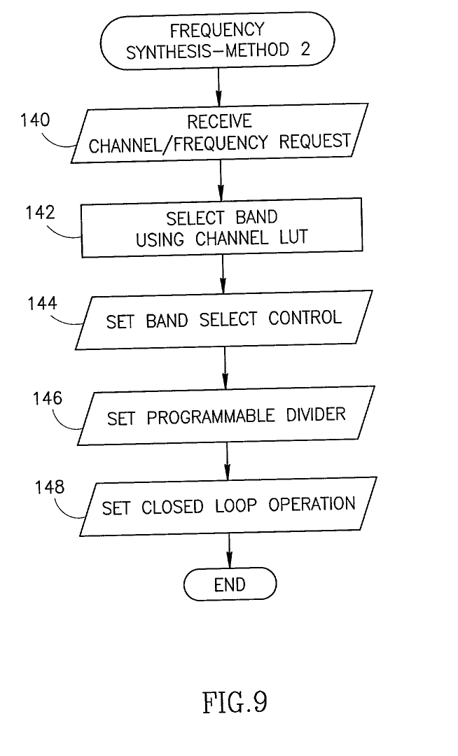

The second embodiment will now be described in more detail. A flow diagram illustrating a first frequency synthesis method of the present invention is shown in FIG. 9. In this embodiment, a band select and channel LUT are generated a priori during a calibration stage. The channel LUT is used to rapidly determine the band corresponding to a desired channel or frequency.

It is assumed that initially, the controller receives a channel or frequency request from an external source, i.e. host controller, etc. (step 140). For example, the synthesizer may be used to generate the carrier or the local oscillator in a frequency hopping transmitter, receiver or transceiver. The controller then performs a lookup on the channel using the channel LUT 36 (step 142). In accordance with the band related information read from the channel LUT, the controller sets the band select control to configure the VCO (step 144). The programmable divider/counter is configured for divider operation and a value corresponding to the desired channel is programmed into the divider (step 146). The loop is then set for closed loop operation (step 148).

It is noted that this second embodiment does not require frequency measurement during regular operation, only during calibration. In addition, calibration can optionally be performed after initialization on a periodic or any other basis such as to compensate for possible variances (e.g., due to temperate changes).

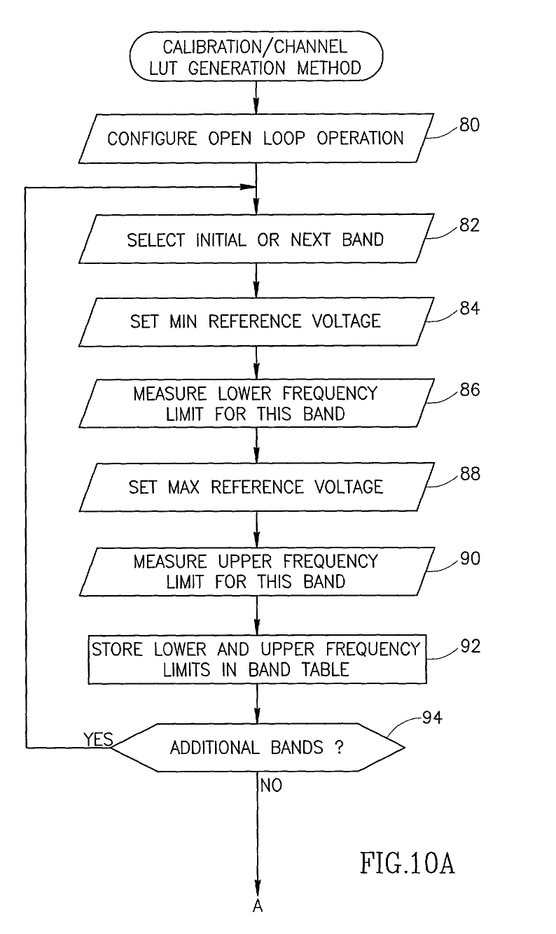

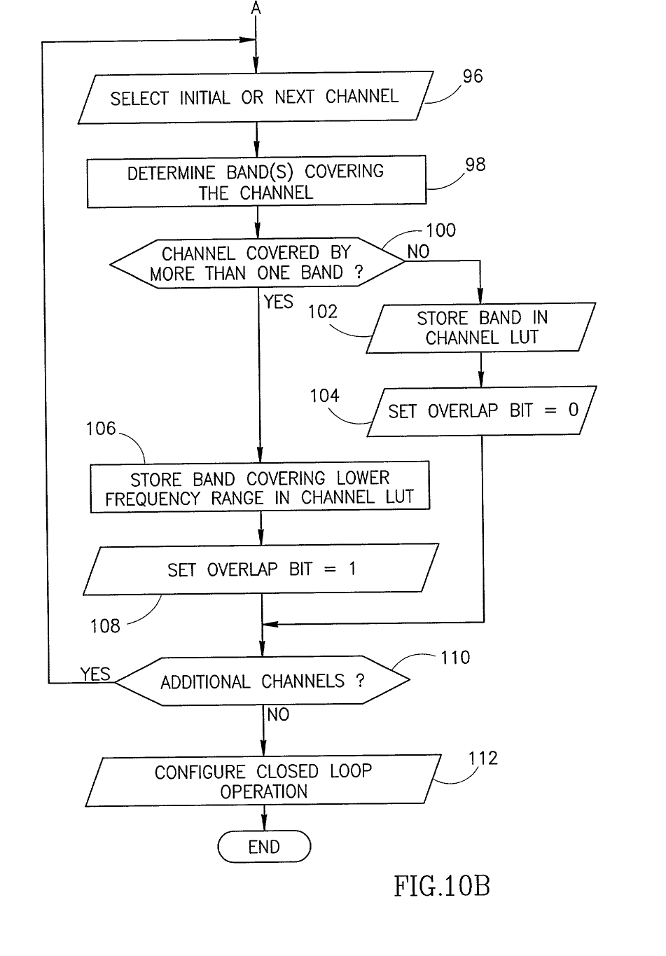

A flow diagram illustrating the calibration and channel LUT generation method of the second embodiment is shown in more detail in FIGS. 10A and 10B. The calibration method is operative to populate both the band LUT and the channel LUT, wherein the contents of the band LUT are used in the generation of the channel LUT. In determining the band LUT, all possible bands are then stepped through and the minimum and maximum frequencies within each band are measured and stored in the band LUT.

First, the controller configures open loop operation (step 80) and the initial or next band is selected and the VCO configured accordingly (step 82). The reference voltage generator is set to generate a minimum input voltage to the VCO (step 84). The lower frequency limit is then measured using the method of FIG. 3 described supra (step 86). The maximum reference voltage is then set (step 88) and the upper frequency limit for the band is measured (step 90). The lower and upper frequency limits are stored in the band table (step 92).

The next band is selected and the lower and upper frequency limits of the band are measured and stored. The process repeats until the last band is processed (step 94). The channel LUT is then generated as described below. Note that the following may be performed offline and therefore does not cause delays in normal operation (e.g., then requested to hop from one frequency to another).

The initial or next channel is selected (step 96). It is assumed that the controller has knowledge of the desired channels and their corresponding frequencies. In addition, it is assumed that the frequency assignment scheme used is ¼ band overlapping as shown in FIG. 6. For each channel, the band or bands that include the particular channel frequency are determined using the lower and upper frequency limits for each band stored in the band LUT (step 98). If the channel is covered by only a single band (step 100), the band is stored in the channel LUT (step 102) and an overlap bit associated with the channel is set to zero and stored therein (step 104).

If the channel is covered by more than one band, than the band covering the lower frequency range is stored in the channel LUT (step 106). The overlap bit is set to one and stored therein (step 108). If there are additional channels to process (step 110), the process repeats with step 96. Once all the channels have been processed, the synthesizer loop is configured for closed loop operation (step 112).

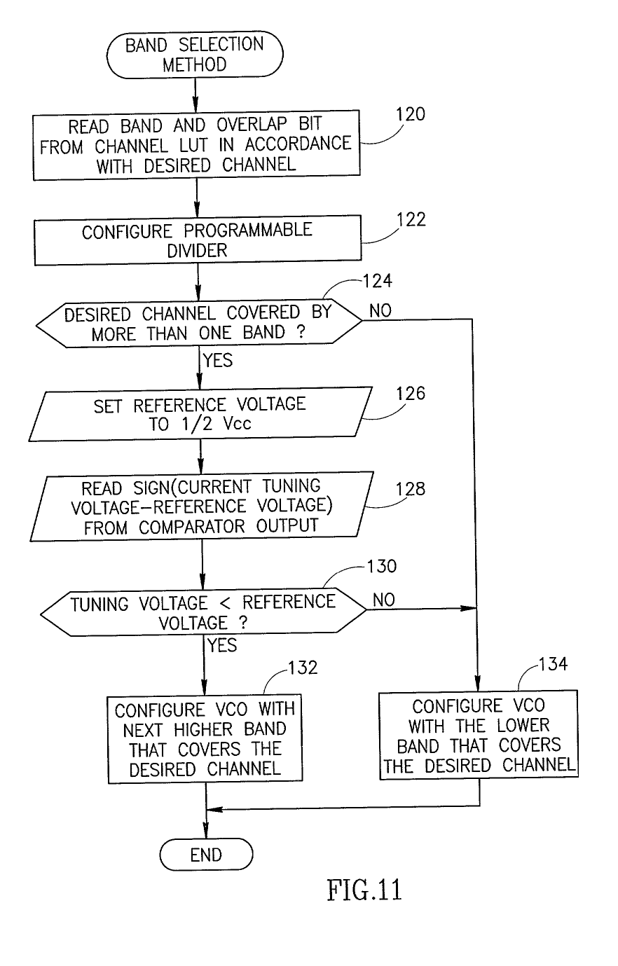

During operation of the frequency synthesizer, the overlap bit is used in selecting the band to use. A flow diagram illustrating the band selection method of the present invention is shown in FIG. 11. First, the band and overlap bit corresponding to the desired channel is read from the channel LUT (step 120). The programmable divider is configured with the appropriate value in accordance with the desired channel (step 122). It is then checked whether the desired channel is covered by more than one band (step 124). This is done by examining the overlap bit read from the channel LUT. If the desired channel is covered by only a single band, the VCO is configured with the band (step 134).

If the desired channel is covered by more than one band, the controller instructs the reference voltage generator to generate ½ V_{CC} (step 126). The upper/lower output U/L generated by the comparator 38 is read by the controller (step 128). This signal represents the sign of the difference of the current tuning voltage and the reference voltage. The inputs to the comparator comprise the loop filter output voltage and the reference voltage. The comparator generates a logic signal indicating whether the tuning voltage is currently (due to previously set frequency) in the lower or upper half of a band. If the tuning voltage is less than the reference voltage (step 130), indicating that the current VCO output is in the lower half of a band, the VCO is configured with the next higher band (step 132). If the tuning voltage is greater than the reference voltage (step 130), indicating that the current VCO output is in the upper half of the band, the VCO is configured with the band read from the channel LUT (step 134).

The band selection method of the present invention provides the advantage of limiting the maximum movement of the VCO's tuning voltage to ¾ of the maximal swing upon switching to a new channel. The method attempts to keep the tuning voltage in the same portion of the band from one channel switch to another. In comparison, when the bands do not overlap at all, as in FIG. 5, the maximum tuning voltage change required is equal to the maximum swing (Vₘₐₓ-Vₘᵢₙ). In addition, in the scheme of FIG. 5, there could, in practice, be ‘holes’ in the bands containing channels that are not covered due to inaccuracies.

It is appreciated that the frequency synthesizer of the present invention be adapted to construct any number of alternative embodiments and is not limited to the two examples described hereinabove. For example, the second embodiment may be modified to perform frequency measurement as a check after a band has been selected and the VCO configured. In addition, the channel LUT or band LUT may be used in the first embodiment as the basis of the initial guess for the band selection.

In alternative embodiments, the present invention may be applicable to implementations of the invention in integrated circuits or chip sets, wireless implementations such as Bluetooth compatible transceivers, wired or wireless communication system products and transmission system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A frequency synthesizer loop, comprising:
a band switching voltage controlled oscillator (VCO) adapted to operate in any of a plurality of bands in response to a band select signal and adapted to generate a VCO output having a frequency proportional to a VCO tuning input signal;
a programmable divider/counter adapted to provide both frequency dividing and frequency counting functions;
a phase comparator adapted to generate signals proportional to the phase differences between a frequency reference signal and a divider output signal so as to generate a phase error signal therefrom;
a loop filter adapted to filter said phase error signal so as to generate said VCO input tuning signal therefrom;
band select means adapted to:
place said frequency synthesizer loop in open loop operation;
measure the frequency of said VCO output utilizing said counter function;
select one of said plurality of bands in response to said frequency measurement; and
place said frequency synthesizer loop in closed loop operation.

2. The frequency synthesizer loop according to claim 1, wherein said band switching VCO comprises a tank circuit having a plurality of circuit elements capable of being switched in and out in accordance with said band select signal.

3. The frequency synthesizer loop according to claim 2, wherein said plurality of circuit elements comprises a plurality of switched capacitors.

4. The frequency synthesizer loop according to claim 1, wherein said loop filter comprises a low pass filter.

5. The frequency synthesizer loop according to claim 1, wherein open loop operation is configured using means for electrically coupling a fixed voltage reference source to the input of said band switching VCO.

6. The frequency synthesizer loop according to claim 1, wherein open loop operation is configured using means for generating a logic signal having a P% duty cycle coupled to the input of said band switching VCO, where P represents the desired fraction of supply voltage (V_{CC}) to be input to said VCO so as to generate the center frequency of a sub-band.

7. The frequency synthesizer loop according to claim 1, wherein said selection of bands comprises repeatedly performing the steps of choosing a band via said band select signal setting and measuring the frequency of said band switching VCO output until a predefined criteria is met.

8. The frequency synthesizer loop according to claim 1, wherein the frequency of said band switching VCO signal is measured by generating a count time window and using said frequency counting function to count the number of pulses received within said count time window.

9. The frequency synthesizer loop according to claim 1, wherein closed loop operation is configured using means for electrically coupling the output of said loop filter to the input of said band switching VCO.

10. A frequency synthesizer loop for generating a plurality of channel frequencies, comprising:
a band switching voltage controlled oscillator (VCO) adapted to operate in any of a plurality of bands in response to a band select signal and adapted to generate a VCO output having a frequency proportional to a VCO tuning input signal;
a programmable divider/counter adapted to provide both frequency dividing and frequency counting functions;
a phase comparator adapted to generate signals proportional to the phase differences between a frequency reference signal and a divider output signal so as to generate a phase error signal therefrom;
a loop filter adapted to filter said phase error signal so as to generate said VCO tuning input signal therefrom;
a channel look up table (LUT) adapted to store band information corresponding to a plurality of channels; and
band select means adapted to select one of said plurality of bands in accordance with band information read from said channel LUT corresponding to a desired channel.

11. The frequency synthesizer loop according to claim 10, wherein said band switching VCO comprises a tank circuit having a plurality of circuit elements capable of being switched in and out in accordance with said band select signal.

12. The frequency synthesizer loop according to claim 11, wherein said plurality of circuit elements comprises a plurality of switched capacitors.

13. The frequency synthesizer loop according to claim 10, wherein said loop filter comprises a low pass filter.

14. The frequency synthesizer loop according to claim 10, wherein said band select means is adapted to perform calibration wherein said channel LUT is configured by:
switching to open loop operation by disconnecting the loop filter and applying a reference voltage to the input of said band switching VCO so as to generate the center frequency of a band;
measuring the center frequency of all possible bands of said band switching VCO;
for each channel, assigning the band whose center frequency is closest to the frequency of the channel; and
switching to closed loop operation by reconnecting the output of the loop filter to the input of said band switching VCO.

15. The frequency synthesizer loop according to claim 14, wherein frequency measurement comprises selecting a band via said band select signal and using said counter function to measure the frequency of said VCO output.

16. The frequency synthesizer loop according to claim 14, wherein said band select means is adapted to perform calibration periodically during operation of said frequency synthesizer.

17. The frequency synthesizer loop according to claim 10, wherein said band select means is adapted to perform calibration wherein said channel LUT is configured by:
switching to open loop operation by disconnecting the loop filter and applying a reference voltage to the input of said band switching VCO;
configuring the bands of said band switching VCO such that they overlap one another by a predetermined amount;
measuring the minimum and maximum frequency of each possible band of said band switching VCO;
assigning a band to a channel whose channel frequency falls within said minimum and maximum frequency of the particular band;
setting an overlap bit associated with said channel if the channel frequency is covered by more than one band; and
switching to closed loop operation by reconnecting the output of the loop filter to the input of said band switching VCO.

18. The frequency synthesizer loop according to claim 17, wherein frequency measurement comprises selecting a band via said band select signal, generating a minimum and maximum reference voltage and using said counter function to measure the minimum and maximum frequency of said VCO output.

19. The frequency synthesizer loop according to claim 17, wherein said band select means is adapted to perform calibration periodically during operation of said frequency synthesizer.

20. The frequency synthesizer loop according to claim 10, wherein one of said plurality of bands is selected by:
reading the band and associated overlap bit corresponding to the desired channel from said channel LUT;
setting said band select signal equal to the band read from said channel LUT if said overlap bit indicates no overlapping band;
setting said band select signal equal to the band read from said channel LUT if said overlap bit indicates an overlapping band and the current VCO output frequency is in the upper half of the band; and
setting said band select signal equal to the next band higher in frequency to the band read from said channel LUT if said overlap bit indicates an overlapping band and the current VCO output frequency is in the lower half of the band.
